(19) United States
(12) Patent Application Publication
(10) Pub. No.: US 2018/0337625 A1
(43) Pub. Date: Nov. 22, 2018

(54) ASSEMBLY FOR STARTING AN ENGINE AND STARTING METHOD

(71) Applicant: THALES, COURBEVOIE (FR)

(72) Inventors: Arnaud DAL, CHATOU (FR); Eric LE GUERROUÉ, CHATOU (FR); Azeddine TAKORABET, CHATOU (FR); Amira MAALOUF, CHATOU (FR)

(21) Appl. No.: 15/981,628

(22) Filed: May 16, 2018

(30) Foreign Application Priority Data
May 18, 2017 (FR) 1700526

(51) Int. Cl. H02P 29/40; F02C 7/268

(52) U.S. Cl. CPC H02P 29/40; F02C 7/268; F05D 2220/50; F05D 2220/323; F05D 2260/85

(57) ABSTRACT

An assembly for starting an engine comprises a starter to supply a required starting torque to the engine to start the engine in a starting phase, the starter being subject to dispersions varying the value of the torque supplied, an electronic starting device linked to the starter to supply an electrical current to the starter to electrically power it in the starting phase. The starter comprises a device for characterizing the dispersions of the starter, the electronic starting device is configured to cooperate with the device for characterizing the dispersions of the starter so as to determine the dispersions of the starter, and the electronic starting device is configured to adjust the electrical current supplied to the starter as a function of the determined dispersions to compensate the dispersions of the starter, so that the starter supplies the required starting torque to the engine.

### CROSS-REFERENCE TO RELATED APPLICATIONS

This application claims priority to foreign French patent application No. FR 1700526, filed on May 18, 2017, the disclosure of which is incorporated by reference in its entirety.

### FIELD OF THE INVENTION

The invention relates to an assembly for starting an engine or an auxiliary power engine in an aircraft. The invention relates also to a method for starting an engine implementing such a starting assembly.

### BACKGROUND

A starter-generator, also known by its acronym S/G, is used as a starter for starting, for example, jet engines, turboprop engines, turboshaft engines for aeronautical use and as a main generator of the on-board electrical network of aeroplanes, helicopters and drones.

The starter-generator is an electrical machine which operates in starter mode to start the engine, then in generator mode to supply the necessary electrical power to the on-board network or any other system requiring electrical power. The electrical machine can be a permanent magnet or wound rotor machine. The electrical machine is a wound rotor machine, it can include a DC or AC, single-phase or three phase excitation stage, brushless with revolving rectifier on the rotor, or it can be excited by a ring-brush system to power the main rotor.

A starter-generator of the synchronous electrical machine type comprises a main machine comprising a main rotor and a main stator in electromagnetic communication with one another. The main rotor comprises at least one rotor winding and the main stator comprises at least one polyphase stator winding. The polyphase stator winding comprises several stator phase windings angularly offset so as to deliver a polyphase alternating voltage. The stator winding and the rotor winding are magnetically coupled. The brushless synchronous starter-generators comprise an exciter comprising an exciter stator comprising an exciter stator winding and an exciter rotor comprising a polyphase winding linked electrically to the rotor winding of the main machine by means of a revolving rectifier bridge. The rotors of the main machine and of the exciter are mounted on a common shaft intended to be coupled to the shaft of an engine.

When the starter-generator operates in starter mode, an alternating current is injected into a stator winding of the exciter. By transformer effect, this alternating current induces an alternating current in the rotor of the exciter. The induced alternating current is rectified by the revolving rectifier bridge and the direct current thus obtained is injected into the rotor winding of the main machine which generates a magnetic field in the main machine. The polyphase stator winding of the main machine is supplied with polyphase alternating current with various frequency. This current produces a revolving magnetic field in the main stator. The interaction between the magnetic field created by the winding of the rotor and the revolving field created by the windings of the stator create an electromagnetic engine torque. The main rotor and the shaft are then driven in rotation and drive the shaft of the engine in rotation.

Moreover, the electrical machine is polyphase: it is generally three-phase, but it can be hexaphase. The invention can extend to any AC electrical machine.

In this application, interest is focused on the starter mode of the starter-generator. The invention is presented with the example of a starter-generator but, more generally, the invention applies to any starter, without the current generation need after the starting phase.

A starting phase can be defined as a phase during which the starter-generator operates in starter mode. The start of the starting phase is initiated by the closing of a starting contactor. The end of the starting phase is reached when the engine reaches the end-of-starting speed. Then, the generation phase begins: the starter-generator operates in generator mode, as main generator for the on-board electrical networks.

To perform the starting function, an electronic starting device is used, called SBU, the acronym for Start Box Unit, to control and power the starter-generator during the starting. The electronic starting device is a power generator whose function is to start, via the starter-generator for example, an auxiliary power unit, the SBU being powered by a 28V DC battery, and to start the main engines, the SBU being powered by a 115V AC network.

There are different control techniques during the starting. The most commonplace techniques are torque control and speed control. It is possible to combine the two techniques, for example with speed control which is followed by torque control beyond a certain operating point, or vice versa.

The torque control technique operates in open loop mode. There is in fact generally no possibility to install a torque metre in the starting chain. The assembly composed of the electronic starting device and the starter-generator then generates a torque from electromagnetic models of the electrical machine or tables of currents as a function of speed of the starter-generator, and measurements performed by the electronic starting device, such as the measurement of the currents supplied by the electronic starting device, the measurement or the estimation of the position of the rotor of the starter-generator.

Various parameters can influence the accuracy of the torque supplied by the assembly composed of the electronic starting device and the starter-generator. The parameters derived from the electronics can for example be cited: the tolerance on the measurement of the currents of the electrical machine, the tolerance of the voltage measurements, the tolerance on the measurement or the estimation of the position of the rotor of the electrical machine, the tolerance on the currents and the voltages generated by the electronic starting device, etc. It is also possible to cite the parameters derived from the electrical machine: the tolerance on the synchronous inductances on the axes d and q in park coordinates, the tolerance on the mutual inductance of the main stage of the machine, the tolerance on the gain of the rotor excitation in the case of a wound rotor machine with exciter, the tolerance on the mutual inductance of the excitation stage, the tolerances on the impedances of the rotor and of the stator of the main stage, the tolerances on the impedances of the excitation stage, the tolerances on the characteristics of the permanent magnets in the case of a permanent magnet machine, the tolerances on the magnetic permeability of the plates of the different magnetic circuits (rotor and stator of the main stage and of the exciter), the tolerances on the air gaps of the main stage and of the exciter, the tolerances on the length of the iron packs of the rotor and stator, the tolerances on the expansion coefficients of the packs of plates of the rotor and the stator, the tolerances on the thicknesses of the plates, the tolerances on the dimensions of the permanent magnets in the case of a permanent magnet machine, etc.

Thus, it can be noted that the accuracy of the torque delivered by the assembly composed of the electronic starting device and the starter-generator can be impacted by many parameters and give rise to dispersions which are mainly, but not exclusively, of electrical, mechanical and/or magnetic origin.

To ensure the success of the starting, the assembly composed of the electronic starting device and of the starter-generator must deliver a required minimum torque denoted Cmin. Generally, it must follow a profile of torque as a function of the speed of the starter-generator.

To guarantee the supply of the required minimum torque Cmin for the starting of the engine, the assembly composed of the electronic starting device and the starter-generator uses as torque reference a reference torque denoted Cref corresponding to the required minimum torque Cmin multiplied by a certain gain in order to compensate the possible dispersion. Thus, if the possible tolerance on torque variation due to the electronics is estimated as +/−a, and that due to the machine as +/−b, it is in theory necessary to increase the reference torque Cref by a multiplying coefficient of 1+a+b. Cref=Cmin×(1+a+b) is then obtained. This makes it possible to guarantee that, in the worst case configuration in terms of dispersion, the torque supplied is always greater than the required minimum torque Cmin, a necessary condition to the success of the starting.

Nevertheless, by proceeding in this way, the result thereof is an overdimensioning of the equipment. This overdimensioning has an impact on the cost, the weight and the volume of the assembly embedded in the aircraft. Since the power taken from the on board network and the power of the assembly composed of the electronic starting device and the starter-generator depend on a and b, there is therefore an obvious interest in reducing a and b as much as possible in order to avoid overdimensioning the equipment.

### SUMMARY OF THE INVENTION

The invention aims to mitigate all or some of the abovementioned problems by proposing a starting assembly that allows for a characterization of the dispersions which influence the torque delivered by the assembly composed of the electronic starting device and the starter-generator allowing for a better dimensioning of this assembly, and thus ensuring the required minimum torque for the starting without overdimensioning the equipment.

To this end, the subject of the invention is an assembly for starting an engine comprising:

a starter intended to supply a required starting torque to the engine to start the engine in a starting phase, the starter being subject to dispersions that vary the value of the torque supplied,

an electronic starting device linked to the starter and intended to supply an electrical current to the starter to electrically power it in the starting phase,

characterized in that the starter comprises a device for characterizing the dispersions of the starter,

in that the electronic starting device is configured to cooperate with the device for characterizing the dispersions of the starter so as to determine the dispersions of the starter,

and in that the electronic starting device is configured to adjust the electrical current supplied to the starter as a function of the determined dispersions to compensate the dispersions of the starter, so that the starter supplies the required starting torque to the engine.

According to one embodiment, the device for characterizing the dispersions of the starter comprises a means for storing a dispersion indicator, and the electronic starting device comprises a means for reading the dispersion indicator.

Advantageously, the dispersion indicator of the storage means is a value defined prior to a use of the starting assembly.

According to another embodiment, the device for characterizing the dispersions of the starter is a passive analogue device.

According to another embodiment, the means for storing a dispersion indicator is an ohmic conductor, and the dispersion indicator is a resistance value.

According to another embodiment, the dispersions of the starter being previously estimated and/or measured, the dispersion indicator is predefined in conformity with the estimated and/or measured dispersions of the starter.

Advantageously, the device for characterizing the dispersions of the starter is a digital device.

The invention relates also to an aircraft comprising such a starting assembly, the motor being a propulsion engine of the aircraft and/or an auxiliary power engine of the aircraft.

The invention relates also to a method for starting an engine implementing such a starting assembly, comprising the following steps:

determination of the dispersions of the starter by the electronic starting device,

adjustment of the electrical current supplied to the starter as a function of the determined dispersions to compensate the dispersions of the starter,

supply of the required staring torque to the engine for the starting of the engine by the starter.

According to one embodiment, the method comprises, beforehand, the following steps performed just once:

estimation and/or measurement of the dispersions of the starter,

predefinition of the dispersion indicator in conformity with the estimated and/or measured dispersions of the starter.

### BRIEF DESCRIPTION OF THE DRAWINGS

The invention will be better understood and other advantages will emerge on reading the detailed description of an embodiment given by way of example, the description being illustrated by the attached drawings in which:

FIG. 1 represents an engine starting assembly according to the invention;

FIG. 2 represents an embodiment of a starting assembly according to the invention;

FIG. 3 schematically illustrates the steps of a starting method according to the invention;

FIG. 4 schematically represents an aircraft comprising a starting assembly according to the invention.

### DETAILED DESCRIPTION

In the interests of clarity, the same elements will bear the same references in the different figures. It should be noted that the invention applies to any type of starter-generator, whether with permanent magnets or with a wound rotor provided with a ring-brush system with DC excitation or brushless with single-phase or three-phase, or more generally polyphase, AC excitation. The invention is presented with the example of a starter-generator but it applies to any type of not necessarily current-generating synchronous or asynchronous starter.

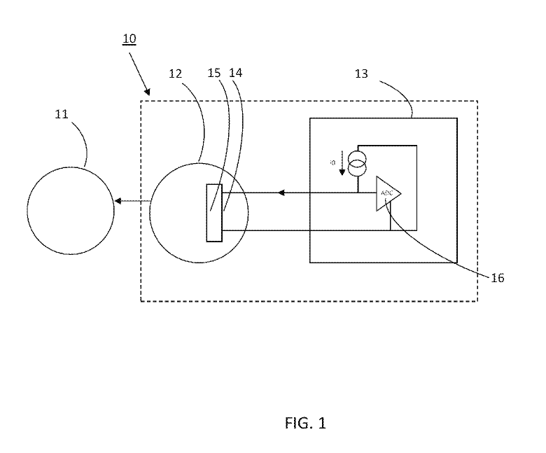

FIG. 1 represents an assembly 10 for starting an engine 11 according to the invention. The assembly 10 for starting the engine 11 comprises a starter 12, for example a starter-generator, intended to supply a required starting torque to the engine 11 to start the engine 11 in a starting phase, the starter 12 being subject to dispersions that vary the value of the torque supplied. The assembly 10 for starting the engine 11 comprises an electronic starting device 13 linked to the starter 12 and intended to supply an electrical current to the starter 12 to electrically power it in the starting phase. According to the invention, the starter 12 comprises a device 14 for characterizing the dispersions of the starter 12, and the electronic starting device 13 is configured to cooperate with the device 14 for characterizing the dispersions of the starter 12 so as to determine the dispersions of the starter 12. Finally, the electronic starting device 13 is configured to adjust the electrical current supplied to the starter 12 as a function of the determined dispersions to compensate the dispersions of the starter 12, so that the starter 12 supplies the required starting torque to the engine 11. The required starting torque is a fixed starting torque which corresponds to the minimum torque to be supplied by the starter to ensure the starting of the engine.

The device 14 for characterizing the dispersions of the starter 12 comprises a means 15 for storing a dispersion indicator, and the electronic starting device 13 comprises a means 16 for reading the dispersion indicator.

The dispersion indicator of the storage means 15 can be a value defined prior to a use of the starting assembly 10, for example +5% or −10% or −12 Nm.

In other words, the invention makes it possible to group together all the construction dispersions of the starter in a device for characterizing same and to use same to be able to compensate them by the current in the starting of the engine. That makes it possible to reach the specified minimum starting torque in all cases. The current can be supplied by an inverter. The inverter is dimensioned so as to be able to supply the current needed to compensate the torque deficit of the least powerful starter. That makes it possible to avoid an overdimensioning (weight) of the starter to guarantee the torque requirement, on the one hand, and to reduce the dispersions of torque supplied on the other hand.

The starting assembly according to the invention allows the starter and inverter assembly to supply a fixed specified minimum torque, independently of the thermal state, and do so in order to minimize the weight of the starter. In other words, the invention makes it possible to produce a fixed given torque regardless of the construction dispersions of the starter itself, outside of the thermal aspects of the engine to be started and of the associated electronics.

According to the invention, the models and parameters of the starter are determined by computation and the models are established in the inverter, and it is only the uncertainties of construction of the starter, including the accuracy of the position coder, which are grouped together with a single “value” datum subsequently processed by the inverter. On an aeroplane, the inverter can be associated with any starter. Also the case on an aeroplane is that the same inverter is used to control the two starters of the two engines having different dispersions.

According to the embodiment considered, the device 14 for characterizing the dispersions of the starter 12 can be a passive analogue device or a digital device. In the case where the device 14 for characterizing the dispersions of the starter 12 is a digital device, it can for example be a ROM memory, a flash memory, an SSD disc, an RFID chip or any other medium capable of storing a dispersion indicator. The electronic starting device 13 is then configured to cooperate with the device 14 for characterizing the dispersions of the starter 12 so as to determine the dispersions of the starter 12. In other words, the starting device 13 then comprises a reading device capable of reading the dispersion indicator on the characterization device 14. Once the dispersion indicator is read by the electronic starting device 13, the electronic starting device 13 is then able to adjust the electrical current supplied to the starter 12 as a function of the dispersions to compensate the dispersions of the starter 12. Thus, the starter 12 supplies the required starting torque to the engine 11. In other words, the starter 12 is thus able to supply the engine 11 with a starting torque at least equal to the minimum torque required to ensure the starting of the engine 11. During the starting, the inverter reads the dispersion value and determines the current by a corrective factor associated with the dispersion value read in order to guarantee the specified minimum torque. The result therefore is a good modularity in the combination of an engine and of an inverter. It is possible to change the inverter without having to associate other additional data therewith since the inverter only reads the dispersion value.

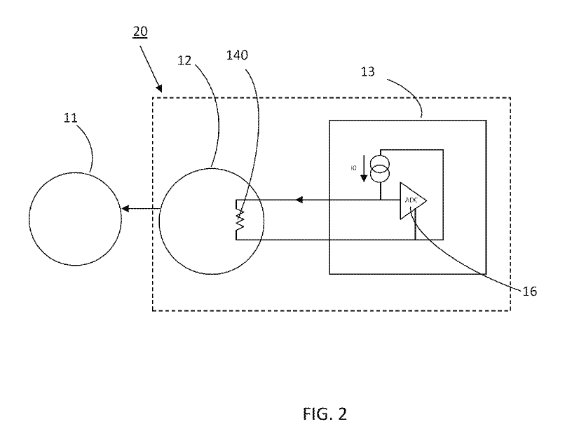

FIG. 2 represents a particular embodiment of a starting assembly 20 according to the invention. The starting assembly 20 of the engine 11 represented in FIG. 2 comprises the same elements as the starting assembly 10 represented in FIG. 1. The difference lies in the device for characterizing the dispersions of the starter 12. In FIG. 2, the device 140 for characterizing the dispersions of the starter is a passive analogue device. More specifically, the means for storing the dispersion indicator is an ohmic conductor, and the dispersion indicator is a resistance value. The dispersions of the starter 12 are estimated and/or measured beforehand, and the dispersion indicator is predefined in conformity with the estimated and/or measured dispersions of the starter 12. During the process of manufacturing the starter 12, for example a starter-generator, tests are performed to identify the parameters influencing the torques supplied by the starter 12. It is then possible, as a function of the operating parameters provided for the starter 12 such as the different tolerances on the impedances of the rotor and of the stator, etc., to estimate the dispersions that the starter 12 will have in use. The dispersions can also be estimated using empirical formulae known to the manufacturer of the starter, by taking into account the operating parameters provided for the starter. Also, the dispersions of the starter can be determined jointly by measurements and estimations.

The estimated and/or measured dispersions are then stored in the characterization device 140 through a dispersion indicator.

In the embodiment of FIG. 2, an ohmic conductor is incorporated in the starter 12. This ohmic conductor has a certain resistance chosen in conformity with the estimated and/or measured dispersions prior to a use of the starter 12. For example, for an estimated dispersion of −6%, the resistance can for example have a value of 1 kΩ (kilo-ohm). The electronic starting device 13, configured to cooperate with the device 14 for characterizing the dispersions of the starter 12, reads the value of the resistance and understands that it has to supply it with a current adapted to compensate the 6% of dispersions of the starter 12 in order for the starter, despite its 6% of dispersions, to be able to supply the minimal torque necessary to start the engine 11.

By proceeding according to the principle of the invention, there is an assurance that the starter delivers the torque required to start the engine, despite the dispersions of the starter. Compared to the prior art and as explained previously, it is therefore no longer necessary to use as torque reference a reference torque Cref corresponding to the required minimum torque Cmin multiplied by a gain in order to compensate the possible dispersions. The invention therefore allows for a saving in terms of cost, of weight and of volume since the equipment such as the starter, the electronic starting device and all the cables, are no longer overdimensioned relative to their size necessary to the correct operation of the starter during the starting.

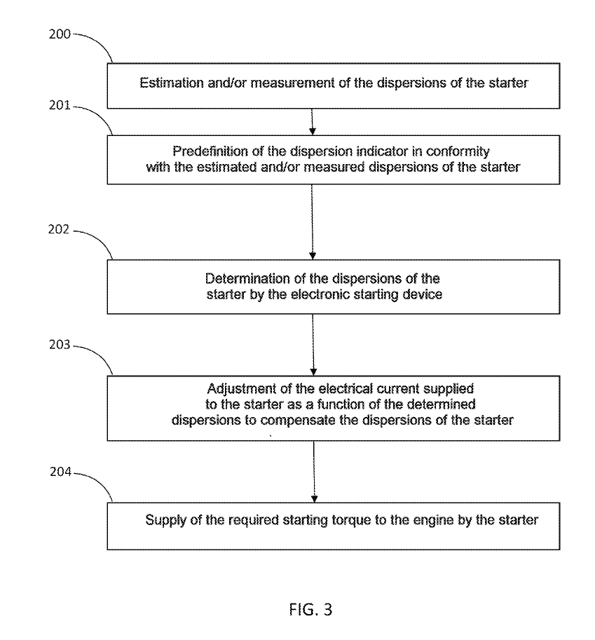

FIG. 3 schematically illustrates the steps of a starting method according to the invention. The method according to the invention comprises a step 202 of determination of the dispersions of the starter 12 by the electronic starting device 13. Then, the method comprises a step 203 of adjustment of the electrical current supplied to the starter 12 as a function of the determined dispersions to compensate the dispersions of the starter 12. Finally, the method according to the invention comprises a step 204 of supply of the required starting torque to the engine 11 by the starter 12 for the starting of the engine 11. By virtue of the method according to the invention, the starter 12 safely and certainly supplies the minimum torque required for the starting of the engine 11 since the electronic starting device 13 is informed of the dispersions of the starter 12 and supplies appropriate electrical current to the starter 12 for the latter to supply the appropriate mechanical torque.

The method for starting an engine 11 comprises, beforehand, the steps 200 and 201 performed just once. During the manufacturing of the starter 12, the step 200 of estimation and/or of measurement of the dispersions of the starter 12, and the step 201 of predefinition of the dispersion indicator in conformity with the estimated and/or measured dispersions of the starter 12, take place.

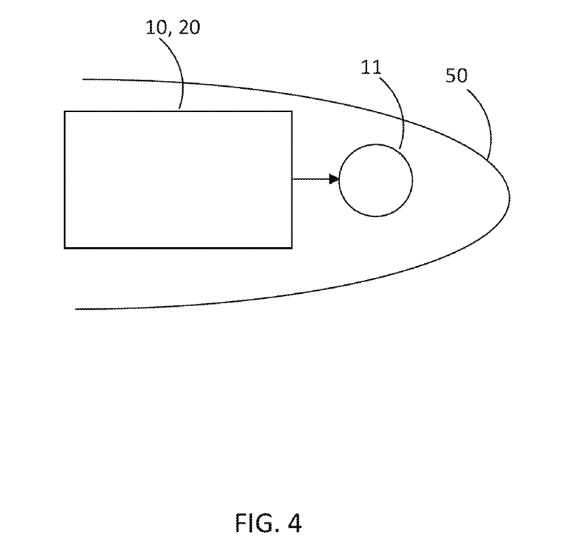

FIG. 4 schematically represents an aircraft 50 comprising a starting assembly 10, 20 according to the invention. The aircraft 50 comprises a starting assembly 10, 20 as described previously. The engine 11 is a propulsion engine of the aircraft 50 and/or an auxiliary power engine of the aircraft 50.

1. A starting assembly for starting an engine comprising:
a starter intended to supply a required starting torque to the engine to start the engine in a starting phase, the starter being subject to dispersions that vary the value of the torque supplied,
an electronic starting device linked to the starter and intended to supply an electrical current to the starter to electrically power it in the starting phase,
wherein the starter comprises a device for characterizing the dispersions of the starter comprising a means for storing a dispersion indicator,
wherein the electronic starting device comprises a means for reading the dispersion indicator and is configured to read the dispersion indicator so as to determine the dispersions of the starter,
and wherein the electronic starting device is configured to supply the electrical current to the starter as a function of the determined dispersions to compensate the dispersions of the starter, so that the starter supplies the required starting torque to the engine.

2. The starting assembly according to claim 1, wherein the dispersion indicator of the storage means is a value defined prior to a use of the starting assembly.

3. The starting assembly according to claim 1, wherein the device for characterizing the dispersions of the starter is a passive analogue device.

4. The starting assembly according to claim 1, wherein the means for storing a dispersion indicator is an ohmic conductor, and wherein the dispersion indicator is a resistance value.

5. The starting assembly according to claim 1, the dispersions of the starter being previously estimated and/or measured, wherein the dispersion indicator is predefined in conformity with the estimated and/or measured dispersions of the starter.

6. The starting assembly according to claim 1, wherein the device for characterizing the dispersions of the starter is a digital device.

7. An aircraft, comprising a starting assembly according to claim 1, wherein the engine is a propulsion engine of the aircraft and/or an auxiliary power engine of the aircraft.

8. A method for starting an engine implementing a starting assembly according to claim 1, comprising the following steps:
determining the dispersions of the starter by the electronic starting device,
adjusting the electrical current supplied to the starter as a function of the determined dispersions to compensate the dispersions of the starter,
supplying the required starting torque to the engine for the starting of the engine by the starter.

9. The method for starting an engine according to claim 8, further comprising beforehand, the following steps performed just once:
estimating and/or measuring the dispersions of the starter, and
predefining the dispersion indicator in conformity with the estimated and/or measured dispersions of the starter.
